(19) United States
(12) Patent Application Publication
(10) Pub. No.: US 2006/0157482 A1
(43) Pub. Date: Jul. 20, 2006

(54) Cooking appliance with a microwave generator device

(76) Inventors: Markus Lingenheil, Kaufbeuren (DE); Peter Kohlstrung, Kaufering (DE); Michael Herner, Landsberg (DE); Joerg Brand, Landsberg (DE); Roland Sterzel, Frankfurt (DE); Bruno Maas, Kaufering (DE); Roland Hegmann, Langerringen (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/301,376

(22) Filed: Dec. 13, 2005

(30) Foreign Application Priority Data
Dec. 13, 2004 (DE) DE2004059900.9-34

(51) Int. Cl. H05B 6/64

(52) U.S. Cl. 219/757

(57) ABSTRACT

A cooking appliance includes a cooking space, a microwave generator device and at least one coaxial transmission line or strip transmission line within the cooking space. The transmission line is connected to the microwave generator device, and is used to outcouple microwave radiation produced by the microwave generator device to the cooking space. The at least one coaxial transmission line and/or strip transmission line may be integrated in at least one component of the cooking appliance in the form of a post or a fixed holder within the cooking space or in at least one accessory which can be introduced into the cooking space. The holder may include a hanging rack, a mobile oven rack or a mobile plate rack to hold insertable cooking containers, plates, sheets and/or pans.

### RELATED APPLICATIONS

This application is related to and claims priority under 35 U.S.C. §119 to German patent application serial number DE 10 2004 059 900.9-34 filed in the German Patent Office on Dec. 13, 2004.

### TECHNICAL FIELD

The present invention concerns a cooking appliance with a cooking space and a microwave generator device and at least one coaxial transmission line or strip transmission line within the cooking space, which is connected to the microwave generator device and through which the microwave radiation produced by the microwave generator device can be outcoupled.

### BACKGROUND ART

One is familiar with cooking appliances with a microwave generator device of many kinds from the state of the art. Thus, for example, microwave generator devices can be integrated in a conventional convection cooking appliance, or cooking appliances are known through which cooking is possible based only on microwave radiation.

A special problem for microwave cooking appliances is that of uniform energy input to the product to be cooked at various treatment levels and rack levels. Frequently it is possible to heat the product to be cooked with the aid of microwave energy only on one to two rack levels, whereby, as a rule, each rack level has its own microwave generator device (for example, including a magnetron). Conventionally, microwave radiation is transported from the microwave generator device to a cooking space through waveguides, which require a relatively large amount of space. This is especially true when several rack levels are to be provided with microwave power in the cooking space of a cooking appliance, in which case the space requirements for these waveguides is disadvantageous.

WO 01/82653 A1 discloses a microwave cooking appliance with a number of levels, each of which can be irradiated with microwaves. Here, the microwave cooking appliance has a waveguide with a number of openings on each level, which horizontally beams microwave radiation on the cooking product introduced into the levels. Each level has a separate microwave generator.

U.S. Pat. No. 4,329,557 describes a microwave cooking appliance which can have several levels. In this device, microwave radiation enters into a cooking space through an opening, is deflected by a sheet and can be guided through waveguides arranged on the sides from an upper region of the cooking space to a lower region of the cooking space. The waveguides can have slits into which a board for holding the cooking product can be inserted. With the aid of these waveguides, it is suggested that it is possible to warm a product to be cooked uniformly even when the product to be cooked is introduced into the lower region of the microwave cooking appliance.

WO 97/19576 A1 describes a microwave cooking appliance with a cooking space into which microwave radiation can be introduced through several openings. In order to be able to control the cooking process better, waveguides from a microwave source can be shut off from the openings with locking means.

A microwave cooking appliance is known from WO 03/079729 A2 in which a product to be cooked can be recognized in a cooking space by the fact that microwave radiation reflected through a small opening of the cooking space is guided toward the outside and detected by a sensor. Then, based on the energy of the exiting microwave radiation, it can be determined whether any and what kind of product to be cooked is present inside the cooking space.

U.S. Pat. No. 4,507,531 discloses a microwave cooking appliance with a cooking space in which the output power of a magnetron is controlled through an anode current as a control quantity so that a cooking process can always be performed the same way, since the power of the magnetron can be controlled accurately.

A cooking appliance with a microwave generator device is also known from U.S. Patent Application Publication No. 2004/0004074 A1, whereby a microwave cooking appliance utilizes a special microwave outcoupling to make the energy input into the product to be cooked in the cooking space uniform. Stated more exactly, the cooking space of this cooking appliance is equipped with several radiation openings for microwaves, whereby, for example, a first radiation opening conducts electromagnetic radiation by reflection to a second radiation opening in the cooking space. Reflected electromagnetic radiation can also be further conducted through the second radiation opening to a third radiation opening. Finally, the electromagnetic radiation reflected through the third radiation opening can be led further to a load, the temperature of which can be measured. The various radiation openings of the microwave cooking appliance are in working connection with a strip transmission line which is located outside the cooking space. The outcoupling of the radiation occurs on the walls of the cooking space.

U.S. Pat. No. 5,170,142 discloses a hermetically sealed connection of a coaxial cable pin to an inner circuit in a radio frequency device where the coaxial cable pin is surrounded by a glass material and a dielectric material. The glass material is heated to its melting point and is then introduced into a housing in order to form, after cooling, a tight connection with the housing, creating a hermetic seal. The coaxial cable pin is thus joined tightly to the housing through the glass material.

A generic cooking appliance is known, for example, from U.S. Pat. No. 4,600,822, which, to be sure concerns a strip transmission line for microwave heating, but does not disclose any details about the arrangement of these elements in the cooking appliance.

A generic cooking appliance is also known from U.S. Patent Application Publication No. 2004/0188429 A1, but here only the transport of microwaves to the cooking space through a coaxial cable is disclosed.

U.S. Pat. No. 5,334,403 concerns a device for thawing, reheating and drying products in a closed treatment space by moving a microwave source over a product layer.

U.S. Pat. No. 6,323,471 B1 concerns, among other things, microwave heating under reduced pressure of an object which is to be dried, concentrated, defrosted, roasted or sterilized, through the use of reflector plates for uniform heating.

DE. 1 937 470 U1 concerns a microwave oven with a multilevel and rotatable oven rack for holding a product to be cooked or treated with microwaves.

### SUMMARY OF THE DISCLOSURE

The task of the disclosed device is to further develop a generic cooking appliance in such a way that the microwave radiation can be guided from the microwave generator device to the product to be irradiated in a space-saving manner. The positioning of the microwave generator device should be as flexible as possible without causing any problems of tightness or stability. Furthermore, the outcoupling of the microwave radiation into the cooking space should occur as close to the product to be cooked as possible.

This task is solved by the fact that at least one coaxial transmission line or strip transmission line is integrated within at least one component of the cooking appliance in the form of a post or a fixed holder within the cooking space or within at least one accessory that can be introduced into the cooking space. Here the holder serves to hold insertable cooking containers, plates, sheets and/or pans and/or one or more accessories, hanging racks, mobile oven racks or mobile plate racks.

Hereby at least one contact- and/or coupling device can be provided to connect the coaxial transmission line or strip transmission line, directly or indirectly, to the microwave generator device in the region of a cooking space wall.

Furthermore, it is possible to make a connection between the contact- and/or coupling device and the coaxial transmission line or strip transmission line, such as, automatically, by introducing the accessory into the cooking space.

Preferably, the contact- and/or coupling device can include a leadthrough through the cooking space wall, preferably in the region of the bottom surface of the cooking appliance, and/or a splitter.

It is also proposed that the contact- and/or coupling device couples at least one coaxial transmission line, such as a first coaxial cable, in the cooking space to a coaxial transmission line, such as a second coaxial cable, outside the cooking space through a plug-in connection.

Hereby, a connecting element, preferably in connection with the coaxial transmission line of the first coaxial cable, and a coaxial pin, preferably in connection with the coaxial transmission line in the form of the second coaxial cable, can be led through an insulating material and a cooking space wall, at least in certain regions.

Again, it can be provided that the connecting element is electrically and/or mechanically connectable or is electrically and/or mechanically connected to the accessory.

It is also proposed that the coaxial pin run at least partly in the connecting element which preferably is in the form of a bolt.

It can also be provided that the insulating material has a recess into which the connecting element can be inserted.

Furthermore, it is proposed that the coaxial pin be arranged in the bottom region of the insulation material.

Furthermore, the insulation material may be comprised of a ceramic, such as steatite or glass.

Preferred cooking appliances are characterized by the fact that the coaxial transmission line in the cooking space includes a conductor, preferably in the form of a round conductor, and a grounded part of the component preferably in the form of a U-shaped profile, wherein the conductor is placed within the grounded part of the component.

Furthermore, the microwave generator device, which may include at least one magnetron, at least one high voltage transformer, at least one heating transformer, at least one capacitor, at least one diode, at least one power supply and/or a cooling device, may be arranged, at least partly, outside of the cooking space, especially outside of the equipment body of the cooking appliance, and preferably in a box or container underneath the cooking appliance.

Other embodiments may be characterized by including at least one antenna in working connection with the coaxial transmission line or the strip transmission line, which may be for example, welded to the round conductor, in order to radiate microwaves into the cooking space.

Furthermore, the component, especially the accessory, may function in working connection with at least one rack for at least one cooking product holder and at least one outcoupling position, at which microwave radiation can be outcoupled from the coaxial transmission line or strip transmission line into the cooking space especially through an antenna, whereby preferably several outcoupling positions and several rack levels are arranged within the cooking space, namely aligned with one another.

Hereby the outcoupling positions for outcoupling the microwave radiation may be directed essentially parallel to the treatment levels for products to be cooked and/or holders for products to be cooked.

It is also proposed that outcoupling positions be arranged directly or diametrically opposite to each other in the treatment level, which is determined by two racks arranged closely next to one another on opposite cooking space walls.

Furthermore, each rack may run between two holders, especially in the form of oven rack posts, which can be connected with at least one contact and/or coupling device, preferably connecting a splitter between them.

Furthermore, the component, especially the accessory, may be placed near a fan wheel provided within the cooking appliance, so that it is removable and/or movable.

Finally, it is proposed that the cooking appliance can be operated with hot air or steam.

Thus, the advantage is based on the surprising finding that, with the cooking appliance described herein, it is possible to reduce the space requirement for the conduction of microwave radiation into a cooking space due to the fact that coaxial transmission lines or strip transmission lines are placed inside the cooking space, which, for the purpose of outcoupling microwave radiation in the cooking space, are integrated in a solid holder within the cooking space or in an accessory which can be introduced into the cooking space. It is especially advantageous when the coaxial transmission lines are formed by or made up of round conductors, which run in the grounded U-shaped profiles of the holder or accessory part, which may take for example, the form of an oven rack. The use of such coaxial transmission lines or strip transmission lines within the cooking space makes it possible to provide flexible adjustment to the product to be cooked introduced into the cooking space, especially its placement so that the outcoupling of the microwave radiation can occur as close to the product to be cooked as possible. For this purpose, the holder or the accessory can preferably have one or several outcoupling position(s) which can be arranged at different heights within the cooking space in order to optimize the outcoupling of microwave radiation with regard to the treatment level for the product to be cooked. For example, an antenna can be welded directly onto a round conductor which can go through an opening in a profile of the oven rack. If coaxial transmission lines or strip transmission lines are integrated in several holders or accessories, the individual outcoupling positions can be set so that they are opposite, for example diagonal, to one another. Similarly, coaxial transmission lines or strip transmission lines can be integrated in all of the holders or supports of accessories. If the radiation of the microwave rays from the outcoupling position is directed parallel to the treatment levels, particularly good energy input into the cooking product to be heated can be achieved.

If a coaxial transmission line or strip transmission line is integrated in an accessory, it is advantageous to provide a contact- and/or coupling device through which the accessory is connected to a microwave generator device arranged outside of the cooking space. Such a contact- and/or coupling device is preferably arranged in the region of the housing wall of the cooking space to which the coaxial transmission line or strip transmission line connects within the cooking space. Outside the cooking space, a coaxial cable can be used as a connecting line between the microwave generator device and the contact- and/or coupling device. The contact- and/or coupling device can thereby be advantageously screened electrically and/or magnetically, can be impervious to steam and/or can be stable to temperatures up to at least 250° C., preferably 300° C. It is also preferred that the coaxial transmission line or the strip transmission line be stable up to a temperature of at least 250° C., preferably 300° C., and/or be able to transport a power of about 1 kW.

Therefore, it is advantageous to conduct the microwave energy from a microwave generator device to a housing wall of a cooking space, for example, through a coaxial cable, which has not been used in the past in cooking appliances and at powers of about 1 kW. The line through the coaxial cable makes it possible to provide a flexible design and flexible positioning of the microwave generator components, which, in addition to a magnetron, can include a high-voltage transformer, a heating transformer, capacitors, diodes and a power supply, for example. Similarly, the use of coaxial cables makes flexible cooling of these components possible, even outside the actual body of the cooking appliance, for example, in a box underneath the cooking appliance provided for this or in a similar structure.

In addition, with the aid of the contact- and/or coupling device, coupling of a, for example, replaceable coaxial pin of a coaxial cable to for example, a replaceable coaxial transmission line arranged in the cooking space can be accomplished through a housing wall. For this purpose, the coaxial transmission line within the cooking space is provided through a connecting element made of insulating material that can be replaced at any time by arbitrary other coaxial transmission lines with corresponding connecting elements. As a result of this replaceability, the cooking appliance can be used more flexibly used.

Furthermore, the contact- and/or coupling device described herein makes it possible to check the microwave compatibility, for example of an accessory, of the cooking appliance. If a connecting element of the accessory plugged into a recess of the insulating material is not microwave compatible, then, using a control or regulation device which is in working connection with a checking device, the microwave generator device can be turned off. Damage of the cooking appliance and of the accessory parts can be thereby prevented. In other words, the cooking appliance can be operated without any danger with standard accessories, that is, without coupling-in of microwaves.

The number of holders or accessories in which the coaxial transmission lines or strip transmission lines are integrated can be adjusted depending on the size of the cooking appliance or on the size of the insertable container in which the product to be cooked is to be heated.

Furthermore, a cooking appliance described herein can be provided with a load recognition device which preferably evaluates the absorbed and/or reflected microwave radiation. With the aid of the load recognition device, measurement of the anode current in the microwave generator device or measurement of an electromagnetic disturbance can be performed, especially utilizing the Bluetooth technology. With the load recognition of the absorbed or reflected microwave radiation, intelligent control of the required microwave power with regard to different treatment levels or even cooking product containers is made possible. Thus, the duration, intensity and the location of the microwave power can be controlled depending on the nature and extent of the loading of the cooking appliance, using appropriate cooking programs. Preferably, the load recognition is automatic.

Using an output control device, the various areas of the cooking space, for example, the different treatment levels for the product to be cooked can be controlled separately. The output control device increases cooking precision, especially for individual control of the microwave radiation power at each of the outcoupling positions in the same cooking space. The output control device can include at least one locking means for the outcoupling positions for partial or complete locking out of these positions.

The coaxial transmission line or strip transmission line itself can be arranged on a fan wheel, so as to save space. The coaxial transmission line or strip transmission line could similarly be arranged on a gas heat exchanger.

Furthermore, at least one locking means and/or at least one sensor, preferably for determining the temperature within the cooking space, can be provided in a cooking appliance at least at one outcoupling position and may be connected to a control or regulation device in working connection with the microwave generator device, the load recognition device, the contact- and/or coupling device, the checking device, and/or the power control device.

### BRIEF DESCRIPTION OF THE DRAWINGS

Other characteristics and advantages of the disclosed device follow as examples from the detailed description of two preferred embodiments given below, with the aid of a schematic drawing. The following are shown:

FIG. 1 is a perspective view of a cooking appliance;

FIG. 2 is a cross-section through a contact- and/or coupling device in the cooking appliance according to FIG. 1; and

FIG. 3 is a partial perspective view of the oven rack of another cooking appliance.

### DETAILED DESCRIPTION

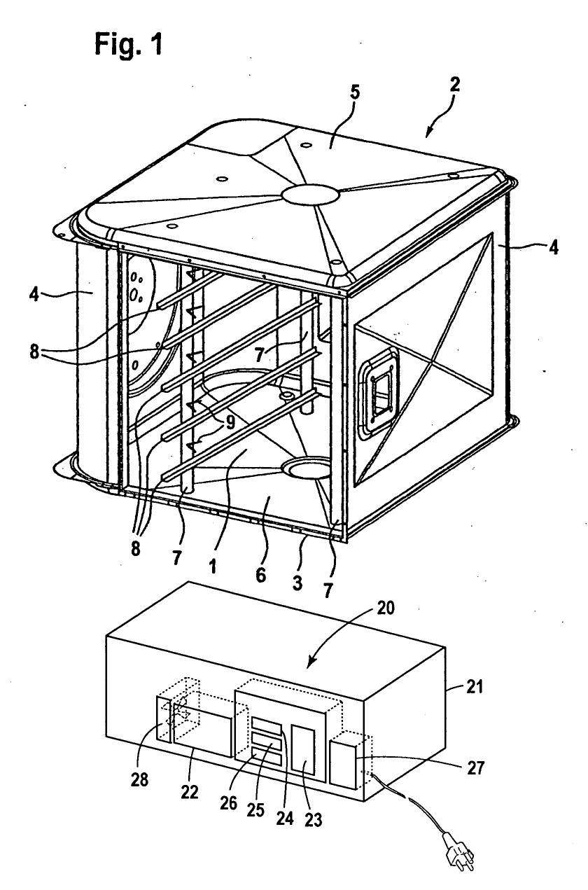

FIG. 1 shows a cooking space 1 of a cooking appliance 2, delineated by a bottom surface 3, side walls 4 and a cover 5, whereby an opening 6 is defined which can be closed, for example by a cooking appliance door which is not shown. Four holders 7 are arranged within cooking space 1 of which three holders can be recognized in FIG. 1. Racks 8 are arranged on the holders 7 into which, for example, food containers (not shown) or similar devices can be pushed and thus placed inside the cooking space. At least one holder 7 is designed with a coaxial transmission line, that is, a coaxial transmission line is integrated into the holder 7. The holder 7 designed as a coaxial transmission line has several outcoupling positions 9 through which the microwave radiation can be radiated from the coaxial transmission line into the cooking space 1. As can be seen from FIG. 1, the arrangement of each outcoupling position 9 or antenna corresponds to a rack 8, so that for each cooking container inserted onto an inserted rack 8, there is at least one outcoupling position 9 alongside the holder 7. As also shown in FIG. 1, a microwave generator device 20 that generates microwave radiation is disposed at least partly outside of the cooking space 1 and, in the embodiment of FIG. 1, is provided in a container 21 underneath the cooking appliance 2. The microwave generator device 20 includes at least one magnetron 22, at least one high-voltage transformer 23, at least one heating transformer 24, at least one capacitor 25, at least one diode 26, at least one power supply 27 and/or a cooling device 28 which operate together to produce microwave radiation for outcoupling into the cooking space 1.

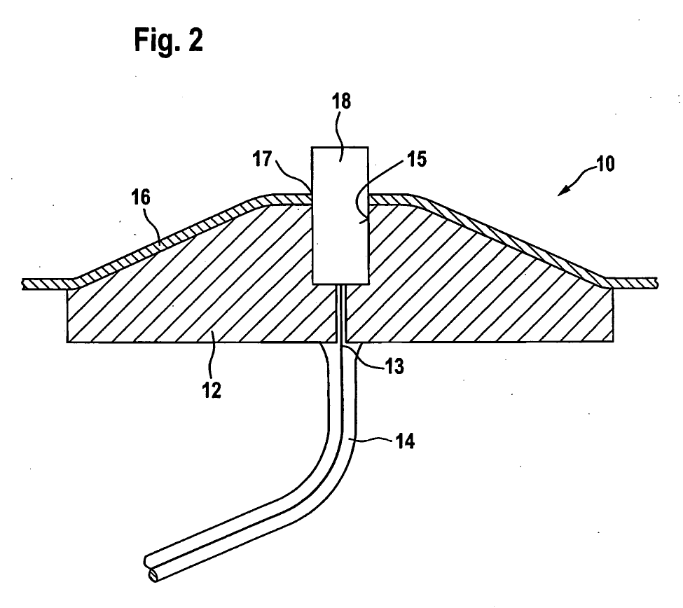

FIG. 2 shows a contact- and/or coupling device 10 for connecting the holder 7, together with its coaxial transmission line and namely in the region of the bottom surface 3 of cooking appliance 2 of FIG. 1, with the microwave generator device 20 which is not shown in FIG. 2. As shown in FIG. 2, a coaxial pin 13 of a coaxial cable 14 is inserted into an insulating material 12. The coaxial cable 14 can be secured through an arbitrary attachment device (not shown) on the insulating material 12. A recess 15 is provided in the insulating material 12, in the bottom region of which the tip of the coaxial pin 13 lies. The insulating material 12, which can be, for example, a ceramic material such as steatite or glass, is arranged in a convex part of the cooking space wall 16 of the bottom surface 3 of the cooking appliance shown in FIG. 1. This cooking space wall 16 has an opening 17 which lies above the recess 15 of the insulating material 12. A connecting element of the coaxial transmission line of the holder 7 of the cooking appliance 2 shown in FIG. 1 can be placed through the opening 17 and into the recess 15. In one embodiment, the connecting element can be a bolt 18. If the bolt 18 is placed in the recess 15 of the insulating material 12, a contact connection between the tip of the coaxial pin 13 and the connecting element 18 of the coaxial transmission line of the holder 7 is facilitated. Thus, the microwave radiation delivered through coaxial cable 14 can be transmitted through the contact- and/or coupling device to the connecting element 18 of the coaxial transmission line, in order to, finally, be outcoupled via antennae within cooking space 1 at the outcoupling position 9. The outcoupling can be regulated through a power control device which is not shown.

As can be seen simply, highly different coaxial transmission lines with the corresponding connecting elements can be inserted into the contact- and/or coupling device 10 in order to make it possible to produce a coupling through coaxial pins 13 and coaxial cable 14 to the microwave generator device 20. Thus, first of all the coupling of replaceable coaxial transmission lines (accessory parts) to the microwave generator device 20 is made possible, and, secondly, a flexible connection is provided between two lines (coaxial pin and coaxial transmission line) inside the insulating material 12.

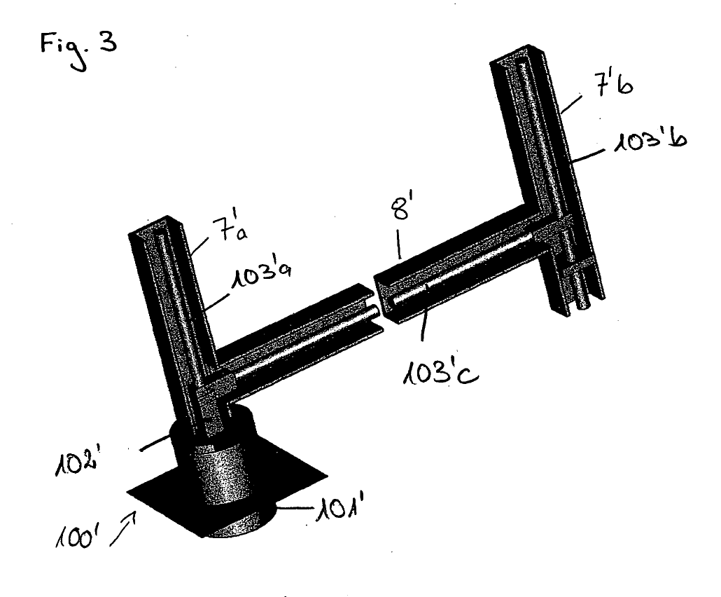

As can be seen from FIG. 3, a coaxial transmission line for the transport of microwaves can also be integrated in a cooking space in an oven rack, which in turn comprises two holders 7′a, 7′b running essentially vertically in the cooking space and a number of racks 8′, running essentially horizontally between them, only one of each of these being shown. Both holder 7′a, 7′b and racks 8′, made in a U-shape essentially for this purpose, accommodate round or tubular conductors 103′a, 103′b, 103′c inside and are grounded. Thus, the oven rack 7′a, 7′b, 8′, together with the round conductors 103′a, 103′b, 103′c provide coaxial transmission lines, specifically in a way that is especially cost-effective and space-saving. The U-configuration of the oven rack profile also makes it possible for fluids to drain.

In the embodiment according to FIG. 3, it is also especially advantageous that, through a microwave generator device, which is not shown in FIG. 3, microwave energy can be fed into a contact- and/or coupling device 100′, which is arranged in the bottom of a cooking appliance (not shown), and in turn has not only a leadthrough 101′ for microwaves, but also a T-shaped splitter 102′, in order to introduce microwave energy to the round conductors 103′a, 103′b in the two holders 7′a, 7′b of the oven rack. In this manner, the oven rack can be installed in a cooking space rotatably around the contact- and/or coupling device 100′. Naturally, the leadthroughs 101′ as well as the splitters 102′ may be introduced through the floor of the cooking space so that they are insulated, such insulation not being illustrated in detail in FIG. 3.

Antennae, which are not shown, can be introduced or connected to the round conductors 103′a, 103′b, 103′c, and for example, may be welded onto the round conductors 103′a, 103′b, 103′c. The antennae can be provided either in the region of both the holders 7′and 7′b or of the racks 8′.

In the structural situation according to FIG. 3, two oven racks are arranged on opposite sides of a cooking space, so that with the aid of two racks 8′ located at the same height, a treatment level is defined for the product to be cooked which is to be irradiated with microwaves through the antennae, in a directed manner.

The characteristics of the invention disclosed in the above specification, in the drawing as well as in the claims may be but are not necessarily essential both individually as well as in any arbitrary combination for the realization of the invention in its different embodiments.

### REFERENCE LIST

1 cooking space
2 cooking appliance
3 bottom surface
4 side wall
5 cover
6 opening
7, 7′a, 7′b holder
8, 8′ rack
9 outcoupling position
10 coupling device
12 insulating material
13 coaxial pin
14 coaxial cable
15 recess
16 cooking space wall
17 opening
18 bolt
20 microwave generator device
21 container
22 magnetron
23 high-voltage transformer
24 heating transformer
25 capacitor
26 diode
27 power supply
28 cooling device
100′ contact- and/or coupling device
101′ leadthrough
102′ splitter
103a′, 103b′, 103c′ round conductor

1. Cooking appliance for use with a microwave generator device comprising:
a cooking space;
at least one cooking appliance component in the form of;
(1) a post or a fixed holder within the cooking space, whereby the holder serves for holding insertable food containers, plates, sheets and/or pans; or
(2) an accessory which can be introduced into the cooking space, wherein the accessory includes a hanging rack, a mobile oven rack, or a mobile plate rack; and
at least one coaxial transmission line or strip transmission line disposed within the cooking space, wherein the coaxial transmission line or strip transmission line is connected to the microwave generator device to guide microwave radiation produced by the microwave generator device to the cooking space and wherein the at least one coaxial transmission line or strip transmission line is integrated in the at least one cooking appliance component.

2. Cooking appliance according to claim 1, further including at least one contact- and/or coupling device that connects the coaxial transmission line or strip transmission line directly or indirectly to the microwave generator device in the region of a cooking space wall.

3. Cooking appliance according to claim 2, wherein the at least one cooking appliance component is the accessory and the contact- and/or coupling device and the coaxial transmission line or strip transmission line are configured so that a connection is formed between the contact- and/or coupling device and the coaxial transmission line or strip transmission line upon the introduction of the accessory into the cooking space.

4. Cooking appliance according to claim 2, wherein the contact- and/or coupling device and the coaxial transmission line or strip transmission line are configured so that a connection is automatically formed between the contact- and/or coupling device and the coaxial transmission line or strip transmission line upon the introduction of the accessory into the cooking space.

5. Cooking appliance according to claim 2, wherein the contact- and/or coupling device comprises a leadthrough through the cooking space wall.

6. Cooking appliance according to claim 2, wherein the contact- and/or coupling device comprises a leadthrough through the cooking space wall in the region of the bottom surface of the cooking appliance, and/or a splitter.

7. Cooking appliance according to claim 2, wherein the contact- and/or coupling device includes a plug-in connection for coupling at least one coaxial transmission line in the cooking space to a second coaxial transmission line outside the cooking space.

8. Cooking appliance according to claim 7, wherein the one coaxial transmission line is a first coaxial transmission cable and the second coaxial transmission line is a second coaxial transmission cable.

9. Cooking appliance according to claim 8, wherein a connecting element in connection with the coaxial transmission line in the form of the first coaxial cable and a coaxial pin in connection with the coaxial transmission line in the form of the second coaxial cable are guided through at least part of an insulating material and a cooking space wall when the plug-in connection couples the at least one transmission line in the cooking space to the second transmission line outside of the cooking space.

10. Cooking appliance according to claim 2, wherein the contact- and/or coupling device includes a plug-in connection for coupling at least one transmission line in the cooking space to a second transmission line outside the cooking space.

11. Cooking appliance according to claim 10, wherein a connecting element and a coaxial pin are guided through at least part of an insulating material and a cooking space wall when the plug-in connection couples the at least one transmission line in the cooking space to the second transmission line outside of the cooking space.

12. Cooking appliance according to claim 11, wherein the connecting element is adapted to be mechanically and/or electrically connected to the accessory.

13. Cooking appliance according to claim 11, wherein the coaxial pin runs at least partially in the connecting element.

14. Cooking appliance according to claim 13, wherein the connecting element is in the form of a bolt.

15. Cooking appliance according to claim 11, wherein the insulation material has a recess, into which the connecting element can be inserted.

16. Cooking appliance according to claim 11, wherein the coaxial pin is arranged in the bottom region of the insulating material.

17. Cooking appliance according to claim 11, wherein the insulating material comprises a ceramic material or a glass material.

18. Cooking appliance according to claim 17, wherein the ceramic material is steatite.

19. Cooking appliance according to claim 1, wherein the coaxial transmission line in the cooking space comprises a conductor and a grounded part of the component.

20. Cooking appliance according to claim 19, wherein the conductor is in the form of a round conductor.

21. Cooking appliance according to claim 19, wherein the grounded part of the component is provided in the form of a U-shaped profile.

22. Cooking appliance according to claim 19, further including at least one antenna in working connection with the coaxial transmission line for radiation of microwaves into the cooking space.

23. Cooking appliance according to claim 22, wherein the coaxial transmission line includes a round conductor and the antenna is welded to the round conductor.

24. Cooking appliance according to claim 1, wherein the microwave generator device includes at least one magnetron, at least one high-voltage transformer, at least one heating transformer, at least one capacitor, at least one diode, at least one power supply and/or a cooling device, and is disposed at least partly outside of the cooking space.

25. Cooking appliance according to claim 24, wherein the microwave generator device is provided-in a-container underneath the- cooking appliance.

26. Cooking appliance according to claim 1, wherein the component is in working connection with at least one rack for at least one cooking product holder and at least one outcoupling position from which the microwave radiation from the coaxial transmission line or strip transmission line can be outcoupled.

27. Cooking appliance according-to claim 26, including an antenna which outcouples the microwave radiation from the coaxial transmission line or strip transmission line.

28. Cooking appliance according to claim 26, wherein the component is in working connection with several racks and several outcoupling positions arranged within the cooking space.

29. Cooking appliance according to claim 28, wherein the several outcoupling positions and several racks are arranged within the cooking space so as to be aligned with one another.

30. Cooking appliance according to claim 28, wherein the outcoupling positions for the outcoupling of microwave radiation are aligned essentially parallel to treatment levels for a product to be cooked or cooking product holders.

31. Cooking appliance according to claim 30, wherein each rack runs between two holders which can be connected with at least one contact- and/or coupling device.

32. Cooking appliance according to claim 31, wherein the two holders are mobile oven racks.

33. Cooking appliance according to claim 31, further including a splitter disposed between the at least one contact- and/or coupling device and the two holders.

34. Cooking appliance according to claim 28, wherein the outcoupling positions are diametrically or directly opposite to one another in a treatment level, which is determined by two racks placed closely on two opposite cooking space walls.

35. Cooking appliance according to claim 1, wherein the component is arranged near a fan wheel-provided within the cooking appliance and is separable and/or moveable.

36. Cooking appliance according to claim 35, wherein the component is the accessory.

37. Cooking appliance according to claim 1, wherein the cooking space can be operated with hot air and/or steam.

38. Cooking appliance according to claim 1, further including at least one antenna in working connection with the coaxial transmission line or the strip transmission line for radiation of microwaves into the cooking space.
